(19) United States
(12) Patent Application Publication
(10) Pub. No.: US 2009/0278660 A1
(43) Pub. Date: Nov. 12, 2009

(54) CREDIT CARD PROTECTION SYSTEM

(76) Inventors: Arthur A. Beisang, White Bear Lake, MN (US); Rodney P. Landers, Minneapolis, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/402,235

(22) Filed: Mar. 11, 2009

Related U.S. Application Data
(60) Provisional application No. 61/051,869, filed on May 9, 2008.

(51) Int. Cl. G05B 19/00

(52) U.S. Cl. 340/5.82

(57) ABSTRACT

The present invention provides positive protection for the machine readable credit card, debit card, etc., against theft by eliminating the presence of visible identifying and correlating information on the credit card or debit card itself until the card is activated by a wireless biometric verification system. The preferred mode of verification includes fingerprint data from the user.

### CROSS-REFERENCED TO RELATED APPLICATIONS

This application is a non-provisional application of Application No. 61/051,869, filed May 9, 2008, and claims priority from that application which is also deemed incorporated by reference in its entirety in this application.

### STATEMENT REGARDING FEDERALLY SPONSORED RESEARCH OR DEVELOPMENT

Not applicable

### BACKGROUND OF THE INVENTION

I. Field of the Invention

The present invention relates generally to a system for controlling access to the use of a personal scanable transaction enabling device and, more particularly, the invention relates to a wireless biometric identification system for correlating the identity of a user with a credit or debit card, or the like, that protects the integrity of personal card data by limiting card activation and eliminating visual human readable data from the card until the card is activated.

II. Related Art

The financial loss due to theft of credit cards for institutions issuing credit cards is in the billions of dollars each year. For example, in one method credit card thieves use to commit fraud after a wallet or purse containing a credit card or debit card is stolen or is found generally as follows. The thief removes each ID card and/or other card of interest from a victim's wallet or purse then, using a cell phone camera, or the like, takes a picture of the front and the back of each card and each credit card capturing the relevant data. The cards are then returned to the purse or wallet and the purse or wallet is dropped in a place where it is obvious so that it can be immediately returned to the owner. When the owner of the credit cards notices that his or her cash is gone but the credit cards are still in place the owner of the credit cards experience a false sense of relief and does not inquire as to use of the cards by others. Meanwhile, the data can be used in on-line or phone transactions by thieves.

Financial institutions currently employ, generally, two types of encoding methods in the credit card business. A machine readable magnetic strip of material is used to contain the digital code for the individual account number, expiration date, etc. in most cards. Another secured type of credit card utilizes a radio frequency identification device. The identification data, account number, etc. is programmed into the processor portion of the device which information is transmitted via a radio frequency when the device is brought near a scanner.

Credit cards and debit cards all have a magnetic strip which contains the 16 digit identification account number. This identification strip is used in the worldwide infrastructure of the credit card companies and their vendors to automatically record each purchase or debit. Once a thief obtains the necessary information, the name, address, credit card number, expiration date and the three-digit security number on the back of the card can be used to purchase items by phone, on the Internet, etc. There are many other ways that credit cards and debit cards can be used to commit fraud once the identification data is obtained.

Given the above situation, there exists a definite need to give one the ability to use a machine readable card for point-of-sale credit transactions that can be uniquely identified with the user, yet which will not reveal identifying data to unauthorized third parties who by chance obtain possession of the card.

Accordingly, the present invention is designed to diminish the amount of financial loss that is due to the theft of identification information from credit cards and debit cards.

### SUMMARY OF THE INVENTION

The present invention provides positive protection for the machine readable credit card, debit card, access card, etc., against theft by eliminating the presence of visible identifying and correlating information on the credit card or debit card itself until the card is activated by a wireless biometric verification system. The preferred mode of verification includes fingerprint data from the user.

In one embodiment of the invention, the credit card or other card of interest is housed in a small thin holder that contains wireless microchip technology, along with a fingerprint sensor that activates the magnetic strip on the back of the card for a short, specific period of time or for a specific number of transactions. No human readable identifying data appears on the card other than possibly, and optionally, the identity of the issuer. When the card is removed from the holder and the user's fingerprint is confirmed, the card is activated for one or possibly a plurality of sequential transactions and the card can be used to swipe in any merchant scanner to affect a purchase. When the card is in the active mode or state, the identity information may be caused to appear on a small series of LCD screens on the surface of the cardholder only during the period of time that the card is activated. Once activated the activated card can be used by any ATM machine in a normal manner.

In a second embodiment of the present invention an electronic circuit microchip is embedded in the card of interest that continuously emits a scrambled radio frequency signal when energized by a card scanner. The owner of the radio frequency ID device uses an integrated biometric sensor such as an Authentech fingerprint sensor to enable the radio frequency ID signal that has been assigned to the owner to be energized by the scanner for a specific transaction or number of transactions. In this embodiment, the radio frequency identification portion of the device is not necessarily detachable and the entire device, including the biometric circuitry, can be housed in a small, convenient, tamper-proof module. In this second embodiment of the invention, biometric identification and other information of the person issued the radio frequency ID device may or may not be visually or electronically displayed on the device.

It will be appreciated that a radio frequency identification device that is stolen or lost, could not be used by a person other than the person that it was issued to because an individual biometric unique to the person issued the device is necessary to enable the device to activate and only for a specific number of transactions when activated. The system can be programmed to remain in the activated state for 1 or up to n swipes or transactions. Reswipes of an unsensed or incorrectly read strip may also be enabled.

### BRIEF DESCRIPTION OF THE DRAWINGS

In the drawings wherein like numerals depict like parts throughout the same:

FIG. 1 is a schematic representation of a card and holder in accordance with the invention;

FIG. 2 depicts a communication system suitable for use with the card system of the invention; and

FIG. 3 depicts an alternate embodiment of a card in accordance with the present invention.

### DETAILED DESCRIPTION

As indicated, radio frequency identity devices are rapidly coming into use, such as the radio frequency ID devices used by gas companies at gas pumps. In addition, radio frequency ID devices are used in various security situations such as opening doors. Currently, if one of these radio frequency identification devices is stolen or lost, it can be used by a non-owner to make purchases or access secure areas. The present invention can also be used to prevent persons other than the person the radio frequency identification device is issued to from making purchases or accessing secure areas.

Cards using a radio frequency identification signal from each of the devices described above may be activated by an electromagnetic signal emanating from a vendor's scanner when making a purchase or as normally used. It can also be activated by in the case of opening a locked door with a signal emanating from a security station scanning device. When used to open a lock on a secure area, the signal from the scanner activates the individual radio frequency ID signal and stimulates the radio transmission of the identification signal back to the scanner.

The detailed description contains several embodiments of the concepts of the invention. The embodiments described herein are meant as examples and are not to be considered as limiting on the concept of the invention in any manner.

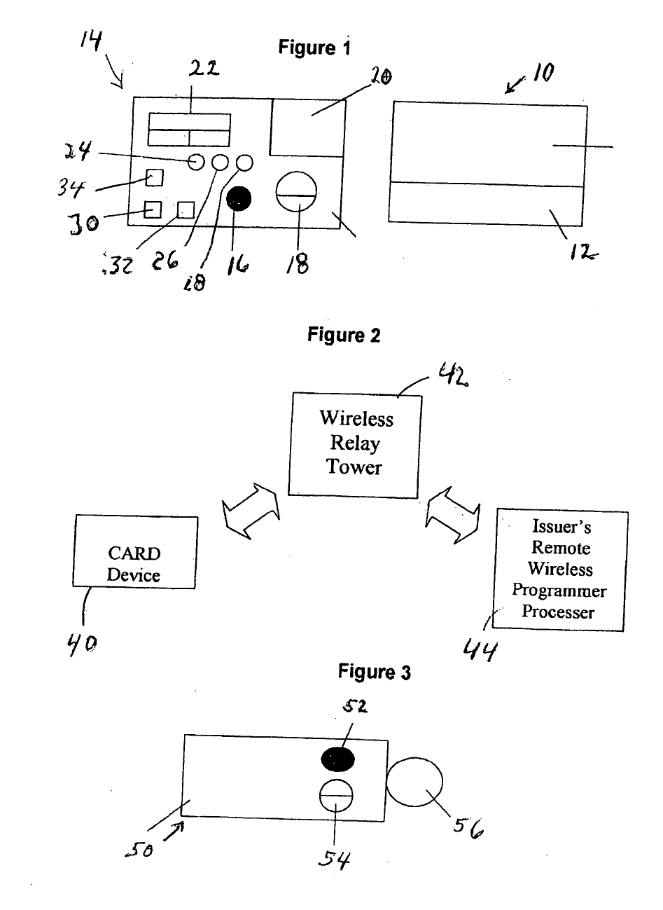

FIG. 1 is a representation of a card and holder in accordance with the invention and includes a card 10 having a machine readable magnetic strip shown at 12. The card is detachable from a cardholder 14 which includes a finger-activated power switch 16 which activates the cardholding device including a fingerprint sensor shown at 18, an image-screen 20, which is used to display any data desired, an LCD screen 22, which can display any type of alpha numeric identity data as desired by the card issuer. Additional indicator lights are shown at 24, 26 and 28, respectively. Additional selector buttons are shown at 30, 32 and 34.

FIG. 2 depicts a possible communication system including the card device being equipped with a RF signal transmitter/receiver at 40 which communicates with a wireless relay tower 42 which, in turn, communicates with the issuer's remote wireless program processor at 44 in a well known manner.

An alternate embodiment is shown in FIG. 3 which includes a radio frequency identification access device 50 equipped with a power button 52 and a fingerprint sensor 54 and which may be used as a key ring attachment as shown at 56.

Thus, it will be appreciated that the invention provides a means of activating the identity data on an access, credit or debit device for a specific limited number of communications. The invention may be applied to any private or commercial communication system which has an infrastructure of at least one location that can be accessed by a device for commercial or private transaction purpose. The invention includes devices to effect a biometric initiated activation by each one in a class of persons individually issued identification data designed to be used to transact an otherwise restricted communication. The transportable device contains a suitable portable energy source.

The device may have a detachable element with a magnetic strip capable of being encoded with an identity digital cipher and a holder element comprised of a biometric sensor that initiates the individual identity data for a specific limited period of time and a means to select one of multiple digital data sets capable of encoding the detachable portion with any one of the data sets selected.

The invention provides a device also which as the ability to display alpha numeric identity data on the holder portion during the period of activation and may display digital biometric images, and also may include an element for communicating digital identification data via audio transmission.

In accordance with the invention, the detachable element may be in the form of a card that can be used in the infrastructure for access machines, ATM machines and vendor credit and debit card scanners.

In addition, with regard to attempted use by non-authorized users, the activation device of the present invention may be one which records the biometrics of a non-authorized user of the device. It may also contain and record the GPS location at the time a non-authorized person attempts a biometric sensing event and, optionally, transmit a wireless signal to a central processor (as shown in FIG. 2) which signal is comprised of the biometric data sensed and the GPS location recorded at the time a non-authorized user biometric sensing event occurs.

In another aspect, conversely the system of the present invention can be implemented so as to be capable of being programmed by wireless transmission from a remote location to receive, record, and process biometric and other information of an individual in a class of persons being issued cards with the protection system of the invention.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A system for protecting personal data pertaining to the identity of a transaction card user or the like comprising:
a) a detachable element with a magnetic strip capable of being encoded with an identity digital cipher; and
b) a holder element comprising a biometric sensor that initiates the individual identity data for a specified limited number of uses and an element to select one of multiple digital data sets capable of encoding the detachable portion with any of the data sets selected.

2. A system as in claim 1 further comprising an alpha numeric display of identity data on said holder portion during a period of activation.

3. A device as in claim 2 further comprising an element for displaying digital biometric images.

4. A system as in claim 3 further comprising an element for communicating digital identification data via audio or radio frequency transmission.

5. A device as in claim 1 wherein the detachable element comprises a card that can be used in the infrastructure for ATM machines and vendor credit and debit card scanners.

6. A system as in claim 1 wherein the biometric sensor records a biometric of a non-authorized user of the device.

7. A system as in claim 1 including an element that captures and records the GPS location at the time a non-authorized person attempts a biometric sensing event.

8. A system as in claim 6 including an element that captures and records the GPS location at the time a non-authorized person attempts a biometric sensing event.

9. A system as in claim 1 including an element which transmits a wireless signal to a central processor which signal is comprised of the digital biometric data sensed and the GPS location at the time a non-authorized user biometric sensing event occurs.

10. A system as in claim 1 further comprising a radio frequency identity emitting device that enables a specific limited number of communications with a scanner of any private or commercial communication system which has an infrastructure of at least one location that can be accessed by a device for commercial or private transaction purposes.

11. A system as in claim 1 wherein said holder includes an energy source.

12. A system as in claim 10 wherein said holder includes an energy source.

13. A system as in claim 1 including a device that can be used with vendor scanning devices or as a means of admission to secure areas controlled by a scanner.

14. A system as in claim 1 which is capable of being programmed by wireless transmission from a remote location to receive, record and process biometric and other information of an individual in a class of persons being issued in any similar systems.

15. A method of enabling a detachable element with a magnetic strip capable of encoded with an identity digital cipher comprising:
a) using a biometric sensor to initiate individual data; and
b) using said biometric individual identity data to enable said detachable element for a specified limited number of uses, using a magnetic strip scanner or radio frequency receiver.
